(19) United States
(12) Patent Application Publication
(10) Pub. No.: US 2008/0150917 A1
(43) Pub. Date: Jun. 26, 2008

(54) OSCILLATOR CIRCUIT FOR USE IN AN UNTETHERED STYLUS

(75) Inventors: Albert H. Libbey, Eliot, ME (US); Martin J. Vos, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/613,571

(22) Filed: Dec. 20, 2006

(51) Int. Cl. G06F 3/033

(52) U.S. Cl. 345/179

(57) ABSTRACT

An untethered stylus is configured to cooperate with a location sensing device that generates a continuously varying magnetic drive signal that powers the stylus. The stylus includes a housing having a tip, a shield, and an antenna arrangement coupled between the tip and shield. A resonant circuit of the antenna arrangement is tuned to a frequency of the magnetic drive signal. An oscillator circuit, coupled to and powered by the antenna arrangement, is configured to oscillate at a frequency corresponding to data to be communicated from the stylus, and to amplitude modulate a voltage developed at the stylus tip at the oscillator circuit frequency. Repetitive current draw from the antenna arrangement to power the oscillator circuit repetitively reduces a voltage at the tip, such that the tip voltage is amplitude modulated at the oscillator circuit frequency.

The present invention relates generally to sensing systems and methods and, more particularly, to sensing systems and methods that employ an untethered stylus as a user input implement.

### BACKGROUND

Personal computing systems of varying type and configuration typically provide one or more user interface devices to facilitate user interaction with such computing systems. Well known user interface devices include a keyboard, mouse, trackball, joystick, and the like. Various types of personal computing devices, such as tablet PCs, provide a pen apparatus that can be manipulated by the user, much in the same way as a pencil or ink pen.

Conventional computing devices that provide for user input via a pen or other pointer implement typically employ an electromagnetic inductive system. The electromagnetic inductive system usually comprises an electromagnetic pen or pointer apparatus and a digitizer in the form of a tablet. Changes in pen location relative to the digitizer's sensing surface are detected and location computations are made to determine the coordinates of the pen.

### SUMMARY OF THE INVENTION

The present invention is directed to effecting communication of information between an untethered stylus and a location sensing device. According to embodiments of the present invention, an untethered stylus is configured to cooperate with a location sensing device, such as a touch location sensing system. The location sensing device is configured to generate a continuously varying magnetic drive signal that powers the stylus. The stylus includes a housing having a tip and a shield. An antenna arrangement of the stylus is coupled between the tip and shield. The antenna arrangement includes a resonant circuit tuned to a frequency of the magnetic drive signal. For example, the antenna arrangement may include a ferrite rod coil antenna coupled in parallel with a capacitor.

An oscillator circuit is coupled to the antenna arrangement and powered by the antenna arrangement. The oscillator circuit is configured to oscillate at a frequency corresponding to data to be communicated from the stylus, and to amplitude modulate a voltage developed at the stylus tip at the oscillator circuit frequency. In one implementation, repetitive current draw from the antenna arrangement to power the oscillator circuit repetitively reduces a voltage at the tip, such that the tip voltage is amplitude modulated at the oscillator circuit frequency. The data to be communicated from the stylus may be analog data or digital data, and typically includes stylus status data.

According to one implementation, the oscillator circuit includes a FET phase shift oscillator. Other oscillator circuit configurations may be employed, such as a comparator oscillator. The oscillator circuit may also be configured to oscillate at a multiplicity of frequencies corresponding to a multiplicity of data to be communicated from the stylus. In such a configuration, a voltage at the stylus tip is amplitude modulated at the multiplicity of oscillator circuit frequencies. The stylus, for example, may include several user-actuatable switches coupled to the oscillator circuit, in which case each of the user-actuatable switches corresponds to one of the oscillator circuit frequencies. One or more of the user-actuatable switches may correspond to one or more mouse functions.

The stylus may be used with a location sensing device comprising a digitizer. The stylus may also be used with a location sensing device that incorporates a digitizer and a touch-sensitive sensor, such as a capacitive touch sensor. The location sensing device preferably includes an amplitude demodulator configured to demodulate the tip voltage amplitude modulation to produce a sinusoid at the oscillator circuit frequency, and a frequency demodulator configured to recover the stylus data.

In accordance with other embodiments, methods implemented in an untethered stylus for use with a location sensing device involve receiving a continuously varying magnetic drive signal generated by the location sensing device, and powering an oscillator circuit of the stylus in response to receiving the drive signal. The oscillator circuit may include a FET phase shift oscillator or other type of oscillator, such as a comparator oscillator, for example. A data signal is generated at a frequency of the oscillator circuit. The data signal may comprise analog or digital data, and typically includes stylus status data. A voltage signal readable by the location sensing device is amplitude modulated using the data signal.

Generating the data signal may involve generating each of a multiplicity of data signals at one of a number of oscillator circuit frequencies. Amplitude modulating the voltage signal may involve amplitude modulating the voltage signal using the multiplicity of data signals. The stylus may include one or more user-actuatable switches each producing one of the multiplicity of data signals, and one or more of the user-actuatable switches may correspond to one or more mouse functions.

Embodiments of the present invention may further involve amplitude demodulating the voltage signal at the location sensing device to produce a sinusoid at the oscillator circuit frequency, and may also involve frequency demodulating the voltage signal at the location sensing device to recover the data signal. A location of the stylus relative to the location sensing device may be determined. In other embodiments, a location of a finger touch, in addition to stylus location, relative to the location sensing device may be determined.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a diagram of a location sensing system that includes an untethered stylus and a location sensing device in accordance with embodiments of the present invention;

FIG. 2 is a diagram of various components of a location sensing device that cooperates with a stylus in accordance with embodiments of the present invention;

FIG. 3 is a diagram of an apparatus for generating an excitation magnetic field which is received by a stylus in accordance with embodiments of the present invention;

FIG. 4 is an illustration showing an approximate spatial distribution of magnetic flux lines associated with an excitation coil of the apparatus shown in FIG. 4;

FIG. 5 is an illustration of various components of a stylus implemented in accordance with embodiments of the present invention;

FIG. 6 shows a schematic model of a parallel coil-capacitor circuit that facilitates an enhanced understanding of the present invention; and

FIG. 7 is a schematic of an oscillator circuit implemented to include a FET phase shift oscillator in accordance with embodiments of the present invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

The present invention is directed to methods and systems for communicating data between an untethered stylus and a location sensing system. Embodiments of the present invention provide for communication of analog and digital stylus information between an untethered stylus and a location sensor, such as a digitizer, via a continuously varying magnetic field. An excitation coil arrangement is provided at the location sensor and employed to produce a continuously varying magnetic field, such as a harmonic magnetic field, in the plane of the location sensor.

The stylus includes an antenna arrangement comprising a resonant circuit that is tuned to resonate at the frequency of a harmonic magnetic field, and derives power from the harmonic magnetic field. A low power oscillator circuit provided at the stylus is configured to oscillate at a frequency corresponding to data to be communicated from the stylus. The oscillator circuit is configured to amplitude modulate a voltage signal at the oscillator frequency. An amplitude demodulator at the location sensor is configured to demodulate the amplitude modulated signal received from the stylus and to produce a sinusoid at the stylus oscillator frequency. A frequency demodulator at the location sensor is configured to detect the stylus data.

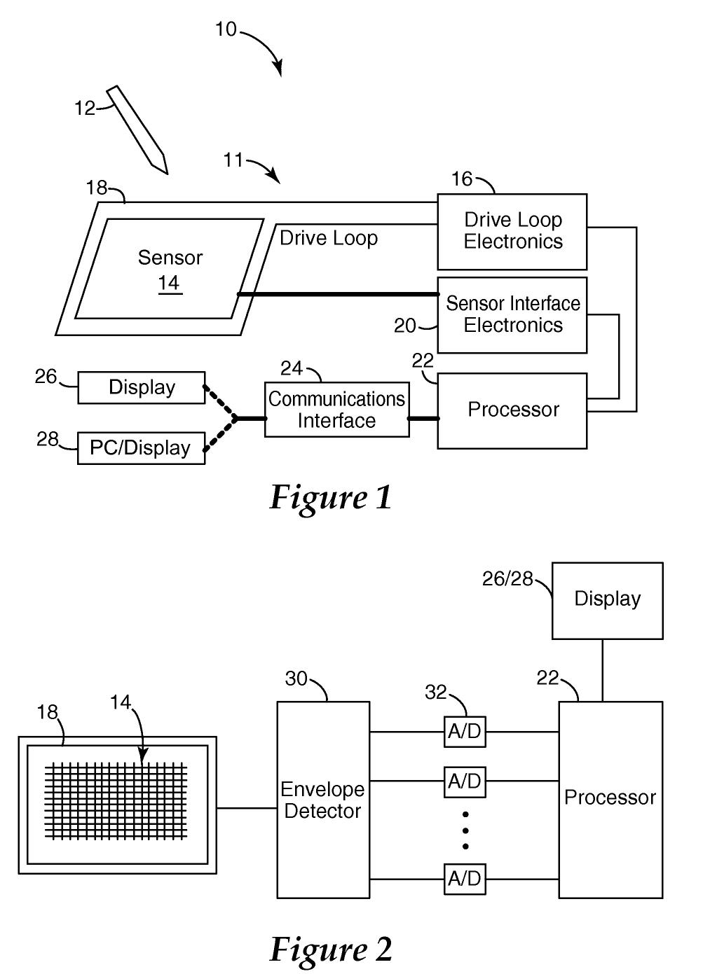

Embodiments of an untethered stylus of the present invention may be implemented in the context of a location sensing system, embodiments of which are illustrated in FIGS. 1-3. According to the embodiments shown in FIGS. 1-3, a location sensing system 10 includes a stylus 12 that interacts with a sensing device 11. The sensing device 11 includes a touch location sensor 14, such as a digitizer. The stylus 12 is configured as a tetherless or cordless implement that does not have a battery. Rather, the stylus 12 derives power from a magnetic field generated by the sensing device 11. Although preferred embodiments of an untethered stylus do not include a battery, some embodiments may employ a battery, such as a rechargeable battery that is recharged from energy derived from the magnetic field of the drive signal. A battery may be used to provide power to various circuits of the stylus, such as a modulator or pressure sensor (e.g., tip or eraser pressure sensor).

The sensing device 11 is shown to include a drive loop or coil 18 coupled to drive loop electronics 16 that cooperate to generate a magnetic field, which may be a continuously varying magnetic field. Drive coil 18 may comprise one or more coils or loops. The stylus 12, having derived power from the magnetic field emanating from the drive coil 18, broadcasts a signal from which stylus location and status may be determined by the sensing device 11.

The stylus 12 is preferably configured to include one or more user-actuatable buttons or switches, such as those commonly employed to implement various mouse functions (e.g., right and left mouse buttons). The tip of the stylus 12 may incorporate a pressure sensor from which applied pressure can be resolved and transmitted to the sensing device 11. Eraser functionality may also be incorporated in the form of a switch or pressure sensor at the stylus end opposite the tip.

Sensor interface electronics 20 is coupled to the sensor 14 and facilitates measurement of signals developed at the sensor 14 in response to signals broadcast by the stylus 12. According to one configuration, the sensor 14 includes a digitizer that incorporates a detection grid and electronics as is known in the art. For example, such a detection grid may include pairs of position resolving conductors each of which forms one or more differential coil elements in the sensor 14, with each conductor pair receiving a magnetic signal transmitted by the stylus 14. An illustrative example of a digitizer having such a detection grid configuration, elements of which may be employed in a location sensor system of the present invention, is disclosed in U.S. Pat. Nos. 4,786,765; 5,218,174; 5,633,471; 5,793,360; 6,667,740; and 7,019,672; which are hereby incorporated herein by reference.

According to another configuration, the sensing device 11 may incorporate a sensor 14 that effectively incorporates a digitizer and a touch-sensitive sensor. The digitizer, according to this configuration, allows the location and status of the stylus 12 to be determined. The touch-sensitive sensor allows the location of a finger touch to be determined. This configuration allows a user to use either the stylus 12 or a finger to indicate a desired location on a computer display, as well as determine the location and status of the stylus 12.

The touch-sensitive sensor 14 typically includes a matrix that capacitively couples to the stylus 12 and/or a finger. In this configuration, the sensor 14 of the sensing device 11 is preferably made up of a series of transparent conductors placed upon a glass or plastic cover that can be placed in front of an LCD display. One side of the glass or plastic sheet has conductors in the X direction, and the opposite side has conductors in the Y direction. Examples of suitable touch-sensitive sensors 14 are disclosed in commonly owned U.S. Pat. Nos. 6,133,906 and 6,970,160, in commonly owned U.S. Published application No. 2005/0083307, in U.S. Pat. Nos. 6,762,752 and 6,690,156, and in U.S. Published application No. 2004/0095333, each of which is hereby incorporated herein by reference.

An embodiment that incorporates a digitizer and touch-sensitive sensor advantageously allows a user to point a stylus at a computer display and have the location and status of the pointing device determined and, when a finger is used to point at the display device, allows for the determination of the location of a finger touch at the display device. The dual use aspects of this embodiment of a sensing device 11 make it particularly useful in tablet PC applications.

For example, a digitizer arrangement allows a user to use a stylus to input information, indicate operations the user wants to take, and write or draw on the display. The touch-sensitive sensor allows the user to “type” information onto a virtual keyboard on the display screen, for example. This would allow the vendor of the computing system, in which a dual touch location sensor system of the present invention is implemented, to eliminate the keyboard and the associated bulk it requires. It is understood that a digitizer and a touch-sensitive sensor need not be implemented together in all configurations, but inclusion of both sensing devices provides for enhanced user interaction with a computing system that incorporates a sensing system 10 of the present invention.

According to one embodiment, the drive coil 18 may be constructed of wire, such as 36 gauge wire, looped several times (e.g., 4 times) around the periphery of the frame of sensing device 11. In one implementation, the drive coil 18 may have an inductance of about 21 μH and an impedance of about 14 Ohms at 100 kHz. The drive coil 18 is connected to a signal generator of the drive loop electronics 16. The signal generator may be configured to produce 200 periods of a 100 kHz sine wave signal gated at 250 Hz. The signal generator may, for example, produce an output signal of 0.4 Vₚₚ, resulting in approximately 28 mA of current that flows in the drive coil 18.

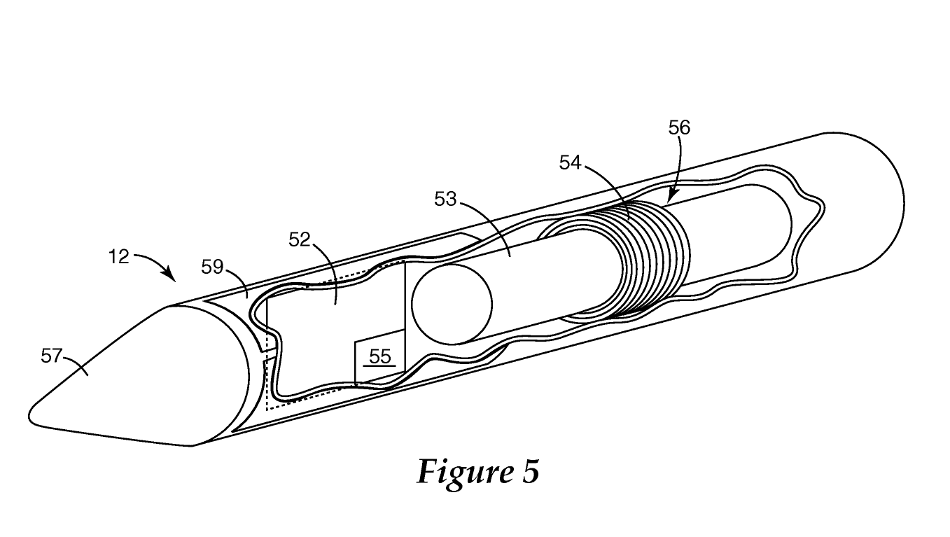

FIG. 3 is a simplified illustration of drive coil 18 and a signal generator 17 that cooperate to generate a harmonic magnetic excitation field. In this illustrative example, one or more coils are preferably arranged in the plane of the touch location sensor. A sinusoidal current is produced by the signal generator 17 with peak magnitude A₁ at radian frequency ω₁ and is applied to the rectangular coil 18. The rectangular coil 18 produces a magnetic field as shown in FIG. 4.

The stylus 12 is configured to collect energy from the magnetic field generated by drive coil 18/drive loop electronics 16 using a tank circuit. The tank circuit is preferably tuned to resonate at the frequency that the drive coil 18 is driven. In this illustrative example, the frequency is set at 100 kHz. The tank circuit of the stylus 12 builds amplitude during the burst produced by the drive coil 18 and then gradually loses signal amplitude after the drive coil 18 is turned off. The time associated with the exponential charging and discharging of the resonant tank circuit of the stylus 12 is determined by the capacitive and inductive elements in the tank circuit.

Referring again to FIG. 1, the sensor interface electronics 20 is preferably connected to the sensor 14 via a shielded connector. The sensor interface electronics 20 includes circuitry for measuring the signal levels present on the individual traces of the sensor 14, and is typically configured to reject as much noise as possible.

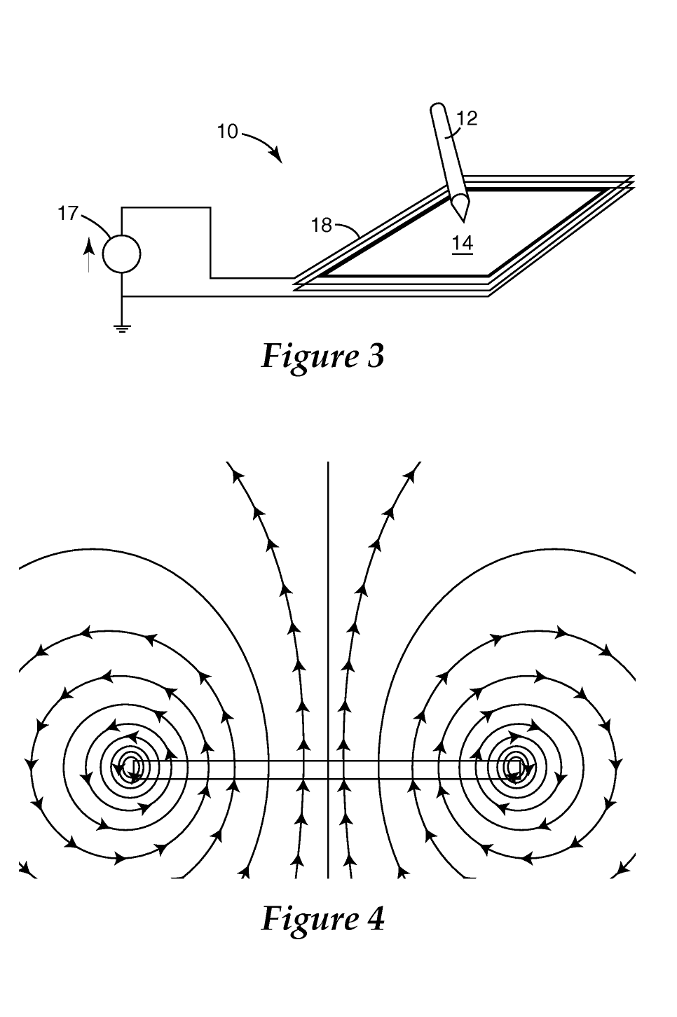

As is shown in FIG. 2, an envelope detector circuit 30 of the sensor interface electronics 20 is configured to detect signals developed on individual traces of the sensor 14. The signals output by the envelope detector circuit 30 are digitized by use of analog-to-digital (A/D) converters 32. Each trace of the sensor 14 may have a dedicated A/D converter 32. Alternatively, two or more traces may share a common A/D converter 32 via a switch having a sufficient switching frequency. The envelope detector circuit 30 is configured to provide sufficient gain to make the resultant signal match the requirements of A/D converters 32. The envelope detector circuit 30 may be configured to generate a signal having the same shape as an imaginary line describing the upper bound of the sensor signal. In such a configuration, the envelope detector circuit 30 effectively transforms the 100 kHz signal into a DC or low frequency signal that is more readily digitized. The envelope detector circuit 30 preferably incorporates one or more synchronous demodulators.

A processor 22 is coupled to the drive loop electronics 16, sensor interface electronics 20, and a communications interface 24, as is shown in FIG. 1. The processor 22 coordinates the operations of drive loop electronics 16 and sensor interface electronics 20, and is configured to determine stylus/finger location and stylus status. Stylus/finger location and stylus status determinations may be made by the processor 22 using known approaches, such as those discussed in the patent references incorporated herein by reference. In one embodiment, processor 22 determines stylus/finger location and stylus status in accordance with the methodologies disclosed in commonly owned U.S. patent application Ser. No. 11/557,829, entitled “Touch Location Sensing System and Method Employing Sensor Data Fitting to a Predefined Curve,” filed on Nov. 8, 2006, which is hereby incorporated herein by reference.

The location and status information computed by the processor 22 is communicated to a computer and/or display 26 via a communications interface 24. The communications interface 24 may be configured as an RS-232 or USB interface, for example. The processor 22 may be configured to drive a display 26 directly. Alternatively, a computer 28 may be coupled to the communications interface 24 and receive the location and status information from the processor 22, and drive its display. The processor 22 or computer 28 may be configured to control cursor velocity, momentum and other factors to enhance the user experience with the sensing system 11.

Referring now to FIG. 5, there is shown an embodiment of an untethered stylus 12 of the present invention that may be implemented in the context of a touch location sensing system as described above or other sensing system known in the art. In accordance with the embodiment shown in FIG. 5, a stylus 12 houses electronics 52, which includes an oscillator circuit 55, and a coil 54 wrapped around a ferrite cylinder 53. The ferrite cylinder 53 serves to increase signal amplitude. An applied harmonic magnetic field produced at the surface of the touch location sensor (e.g., digitizer) or a display, for example, couples flux through the ferrite cylinder 53 and thus to the coil 54 when the stylus 12 is placed in the applied field.

The ferrite coil arrangement 56 resonates with a separate parallel-connected capacitor of the electronics 52 and is tuned to the excitation field frequency. The parallel coil-capacitor combination is connected between the stylus tip 57 and the stylus shield 59. The shield 59 may form part of, or otherwise be connected to, the stylus housing so that it can be touched, and therefore grounded, by a user's hand when held. The shield 59 may be situated to extend over the circuitry region of the stylus 12, and preferably has a discontinuous shape, such as a “C” shape, so as to avoid eddy currents that could otherwise arise in a closed loop shield arrangement.

The stylus tip 57 couples capacitively to the touch location sensor from which location information is derived. To provide stylus status information, the ferrite coil arrangement 56 powers the electronics 52, including a low power oscillator or oscillators provided on oscillator circuit 55, which amplitude modulates the stylus tip voltage at the oscillator(s) frequency or frequencies. The frequency of the oscillations is changed to reflect the stylus status, such as switch closures or tip pressure changes.

Alternatively, the invention may be implemented with magnetic-sensing digitizer systems as are known in the art. An untethered magnetic stylus is similar to the capacitive stylus shown in FIG. 5, except the resonant circuit comprising ferrite coil arrangement 56 and separate parallel-connected capacitor of the electronics 52 need not be connected to tip 57 nor to a shield 59. Untethered magnetic styluses are well known in the art, and are described in previously incorporated U.S. Pat. Nos. 4,786,765; 5,633,471; 5,793,360; 6,667,740, and 7,019,672. Embodiments of the present invention that are implemented using an untethered magnetic stylus may employ a location sensor that includes multiple drive loops as disclosed in the referenced patents. In such embodiments, a separate sensing grid and separate drive loops need not used. Rather, each of the drive loop coils is alternately coupled to transmitting circuitry and then to receiving circuitry to alternately transmit and receive from one of multiple drive loop coils that are placed in the active area, typically under the display.

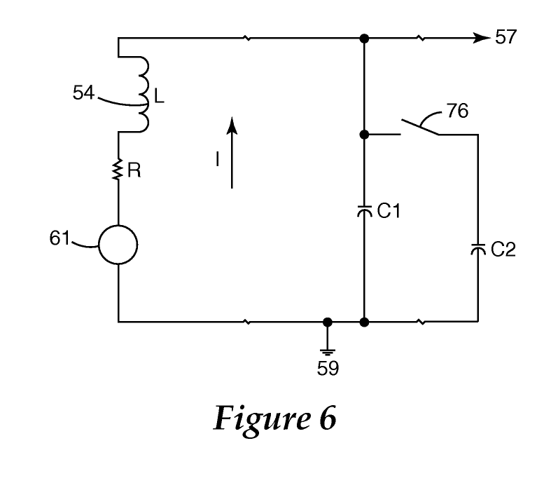

FIG. 6 shows a schematic model of a parallel coil-capacitor circuit that facilitates an enhanced understanding of the present invention. FIG. 6 shows a capacitor C1 connected in parallel with a coil 54 to resonate at the excitation frequency or the transmitted frequency. The voltage developed across the coil 54, which is shown modeled as voltage generator 61, is coupled to the stylus tip 57 and then capacitively coupled to the touch location sensor, such as sensor 14 shown in FIG. 1. The voltage developed across the resonating coil 54 is modulated with one or a combination of the techniques discussed below. An added ferrite cylinder 53 about which coil 54 is preferably wrapped, as shown in FIG. 5, has the effect of increasing the magnetic flux B and signal coupled by the drive coil of the touch location sensor to the receiving coil 54 of the stylus 12.

The capacitance value of capacitor C1 shown in FIG. 6 is selected such that the capacitance, C, of capacitor C1 resonates with the coil inductance, L, at the excitation angular frequency ω so that there is no voltage drop across the LC combination. Two different voltages in this circuit can be considered. The first voltage of consideration is the voltage V (shown in terms of voltage source 61) that develops across the coil 54 through magnetic induction. It is well understood that this voltage 61 is basically equal to the number of stylus coil turns N times the coil cross section A times the rate of change of the magnetic flux density passing through the ferrite cylinder, which is given by V=N*A*dB/dt.

The second voltage of consideration is the voltage that develops across the capacitor C1. This voltage V_{C} is also the stylus tip voltage. From basic circuit analysis at resonance, it follows that: V_{C}=V/(ωRC)=V(ωL/R) with the quantity 1/(ωRC)=(Lω)/R defined as the resonant circuit quality factor Q, where ω is expressed in terms of radians per second. As will be discussed below, this second voltage is modulated for purposes of communicating stylus status data to a touch location sensor.

With continued reference to FIG. 6, one approach to transmitting stylus status information in addition to stylus position information is through addition of a second capacitor C2 connected to the first capacitor C1 through a switch 16. Opening and closing the switch 16 causes the resonance frequency of the coil-capacitor combination 54/C1 to change. This change may be detected by observing a change in phase of the stylus transmitted frequency or though a transient frequency change caused when the drive coil current is turned off.

This method of data transmission, however, is not suitable for a stylus powered by a constantly varying magnetic field and capacitively coupled to the digitizer. Constant excitation does not allow a transient measurement of the stylus resonance, and phase modulation is difficult to detect as the phase of the digitizer received signal varies dramatically as the stylus is moved across the touch location sensor (e.g., digitizer). Frequency modulation of an amplitude-modulated signal in accordance with the present invention removes these difficulties, as it is practical to demodulate the amplitude modulation and detect the frequency of the modulation without having to turn off the excitation coil and in the presence of varying phase.

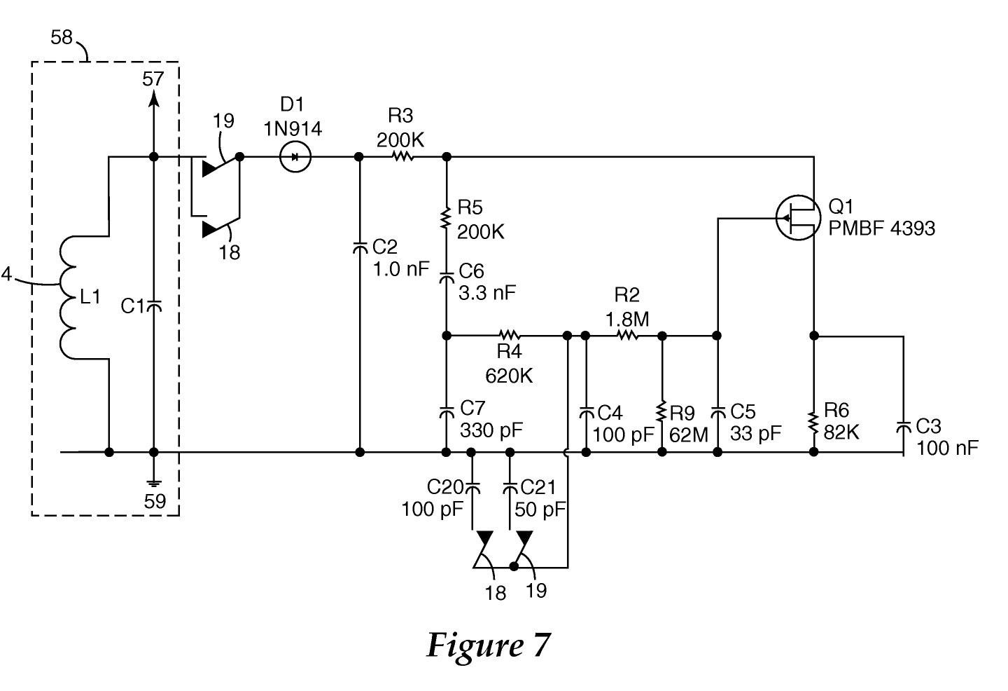

An embodiment of a low power oscillator of the present invention that facilitates frequency modulation of an amplitude-modulated signal is shown in FIG. 7. The oscillator circuit of FIG. 7 is implemented to include a FET phase shift oscillator. Alternative oscillators may be used, such as a comparator oscillator. As is shown in FIG. 7, when either double pole switch 18 or switch 19 is closed, stylus coil circuit voltage is rectified onto capacitor C2. In the presence of voltage on capacitor C2, a transistor (JFET) Q1 will turn on. This causes the voltage on the drain of Q1 to decrease. This decreasing voltage is coupled through the various resistors and capacitors shown in the schematic of FIG. 7 to the gate of Q1 delayed by the various RC time constants. The delayed negative going Q1 gate signal then turns Q1 off. This causes the voltage at the Q1 drain to increase. This increase is delayed to the Q1 gate to cause Q1 to turn on again. This cycle repeats, producing an oscillating signal at the Q1 drain. The frequency of oscillation is controlled by the delay through the R5-R2 filter. Selection of a different capacitor value by switch 18 or 19 (C20 or C21) produces a different delay and a different oscillation frequency. Additional capacitors and switches may be added to accommodate additional stylus switch functionality.

The current drawn from the stylus coil circuit is higher when the transistor Q1 is on. Because the stylus coil circuit powers the oscillator, the higher current draw reduces the stylus tip voltage. As a result, the stylus coil tip voltage is amplitude modulated at the oscillator frequency. In an alternative configuration, the oscillator may be connected to an attenuator placed between the stylus coil circuit and the pen tip, or the oscillator may drive another transistor switch which alternately connects a resistor from the stylus tip 57 to the shield 59. It is understood that FIG. 7 represents a non-limiting exemplary embodiment of oscillator circuitry that may be incorporated in a stylus of the present invention, and that other oscillator configurations may be employed.

Various known amplitude demodulation circuitry may be provided at the touch location sensor to detect the coupled amplitude modulation. Known frequency demodulation circuitry at the touch location sensor may be used to detect the frequency of the amplitude modulation. Stylus pressure or other status button states may be converted to a variable inductance, capacitance, or resistance using known technologies. For example, a pressure sensor provided at the tip of the stylus may incorporate a capacitor whose plate separation varies with force. The variable component value may be used to modulate the oscillator frequency as a function of the force. For example, a variable capacitor or resistor replacing one of the feedback filter components may be used with the FET oscillator describe above. The oscillator frequency will then vary with the resistor or capacitor value, reflecting the stylus pressure.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An untethered stylus configured to cooperate with a location sensing device, the location sensing device configured to generate a continuously varying magnetic drive signal that powers the stylus, the stylus comprising:
a housing comprising a tip and a shield;
an antenna arrangement coupled between the tip and shield, the antenna arrangement comprising a resonant circuit tuned to a frequency of the magnetic drive signal; and
an oscillator circuit coupled to the antenna arrangement and powered by the antenna arrangement, the oscillator circuit configured to oscillate at a frequency corresponding to data to be communicated from the stylus, the oscillator circuit configured to amplitude modulate a voltage developed at the tip at the oscillator circuit frequency.

2. The stylus of claim 1, wherein the oscillator circuit comprises a phase shift oscillator.

3. The stylus of claim 1, wherein the oscillator circuit comprises a FET phase shift oscillator.

4. The stylus of claim 1, wherein the data comprises analog data.

5. The stylus of claim 1, wherein the data comprises digital data.

6. The stylus of claim 1, wherein the data comprises stylus status data.

7. The stylus of claim 1, wherein the antenna arrangement comprises a ferrite rod coil antenna coupled in parallel with a capacitor.

8. The stylus of claim 1, wherein repetitive current draw from the antenna arrangement to power the oscillator circuit repetitively reduces a voltage at the tip, such that the tip voltage is amplitude modulated at the oscillator circuit frequency.

9. The stylus of claim 1, wherein the oscillator circuit is configured to oscillate at a plurality of frequencies corresponding to a plurality of data to be communicated from the stylus, wherein a voltage at the tip is amplitude modulated at the plurality of oscillator circuit frequencies.

10. The stylus of claim 9, wherein the stylus comprises a plurality of user-actuatable switches coupled to the oscillator circuit, each of the plurality of user-actuatable switches corresponding to one of the plurality of oscillator circuit frequencies.

11. The stylus of claim 10, wherein at least some of the plurality of user-actuatable switches correspond to one or more mouse functions.

12. The stylus of claim 1, wherein the location sensing device comprises a digitizer.

13. The stylus of claim 1, wherein the location sensing device comprises a digitizer and a touch-sensitive sensor.

14. The stylus of claim 1, wherein the location sensing device comprises an amplitude demodulator configured to demodulate the tip voltage amplitude modulation to produce a sinusoid at the oscillator circuit frequency, and a frequency demodulator configured to recover the stylus data.

15. A method implemented in an untethered stylus for use with a location sensing device, comprising:
receiving a continuously varying magnetic drive signal generated by the location sensing device;
powering an oscillator circuit of the stylus in response to receiving the drive signal;
generating a data signal at a frequency of the oscillator circuit; and
amplitude modulating a voltage signal readable by the location sensing device using the data signal.

16. The method of claim 15, wherein the oscillator circuit comprises a phase shift oscillator.

17. The method of claim 15, wherein the oscillator circuit comprises a FET phase shift oscillator.

18. The method of claim 15, wherein the data signal comprises analog data.

19. The method of claim 15, wherein the data signal comprises digital data.

20. The method of claim 15, wherein the data signal comprises stylus status data.

21. The method of claim 15, wherein:
generating the data signal comprises generating each of a plurality of data signals at one of a plurality of oscillator circuit frequencies; and
amplitude modulating the voltage signal comprises amplitude modulating the voltage signal using the plurality of data signals.

22. The method of claim 21, wherein the stylus comprises a plurality of user-actuatable switches each producing one of the plurality of data signals.

23. The method of claim 22, wherein at least some of the plurality of user-actuatable switches correspond to one or more mouse functions.

24. The method of claim 15, further comprising amplitude demodulating the voltage signal at the location sensing device to produce a sinusoid at the oscillator circuit frequency.

25. The method of claim 24, further comprising frequency demodulating the voltage signal at the location sensing device to recover the data signal.

26. The method of claim 15, further comprising determining a location of the stylus relative to the location sensing device.

27. The method of claim 26, further comprising determining a location of a finger touch relative to the location sensing device.

28. An apparatus implemented in an untethered stylus for use with a location sensing device, comprising:
an antenna arrangement for receiving a continuously varying magnetic drive signal generated by the location sensing device;
means, powered by the antenna arrangement, for oscillating at a frequency corresponding to data to be communicated from the stylus; and
means, powered by the antenna arrangement, for amplitude modulating a stylus tip voltage at the frequency of oscillation.

29. The apparatus of claim 28, further comprising means for demodulating the voltage signal.
